(19) United States
(12) Patent Application Publication
(10) Pub. No.: US 2010/0307657 A1
(43) Pub. Date: Dec. 9, 2010

(54) SYSTEM AND METHOD OF MAKING PLASTER PANELS

(75) Inventors: Rudy Nicholas Diaz, JR., Murrieta, CA (US); George Wendell Simpson, JR., Phoenix, AZ (US); John W. Kenyon, III, Del Mar, CA (US); Austin Robert Bradley, Poway, CA (US)

Correspondence Address: DUCKOR SPRADLING METZGER & WYNNE;A LAW CORPORATION, 3043 4th Ave., SAN DIEGO, CA, 92103, US

(73) Assignee: NEHEMIAH ELITE WALL SYSTEMS, INC., an Arizona Corporation

(21) Appl. No.: 12/480,601

(22) Filed: Jun. 8, 2009

(51) Int. Cl. B32B 3/04; B32B 13/14

(52) U.S. Cl. 156/40; 156/347; 156/45; 156/42

(57) ABSTRACT

A system and method of making a plaster panel to use in the construction of a wall of a building in a relatively faster, easier, more efficient, and more precise manner for either interior or exterior walls is disclosed. The created plaster panels may include a slab of cementitious composition including a mixture of sizes of cut expanded polystyrene, a quantity of monofilament fiber, and a binding agent. At least one layer of a mesh may surround the slab, wherein the resulting panel is light in weight, flexible and strong. Such panels may be fixed in place to a building frame by suitable fasteners such as nails or screws, while causing little or no fracturing of the panel.

### RELATED APPLICATION

The patent application is related to U.S. patent application entitled PLASTER PANEL AND METHOD OF USING SAME, application Ser. No. ______, filed on ______, and which is herein incorporated by reference.

### FIELD OF THE INVENTION

The present invention relates to a system and method of making plaster panels. The prevent invention more particularly relates to a system and method of making plaster panels used preferably in building construction as a foundation for or in place of stucco, plaster, tile, siding, exterior insulation finish systems, direct applied exterior systems, interior systems, or others.

### BACKGROUND ART

This section describes the background of the disclosed embodiment of the present invention. There is no intention, either express or implied, that the background art discussed in this section legally constitutes prior art.

There have been many systems and methods of making different types and kinds of plaster panels used in building construction. For example, reference may be made to the following U.S. Pat. Nos. 4,298,413; 4,450,022; 4,504,335; 5,221,386; 5,352,390; 5,580,378; 6,187,409; 6,995,098; 7,182,589; 7,255,738; and 7,276,551; as well as Canadian patent 969,700.

Current methods for applying exterior plaster to many commercial buildings may take an undesirably long period of time such as approximately 12 to 13 days under certain circumstances. After application, the plaster may dry for up to 30 days before fractures such as cracks begin to appear. Then, additional plaster may be required to be applied to patch the cracks that formed during the drying phase. In some situations, several exterior coatings may be required to properly finish the wall. Also, when plaster is applied to a long wall, it may be difficult and time consuming to generate a smooth continuous planar surface over the entire length of the wall.

Additionally, during the application of the plaster, there can be waste by draining off of the walls excess amounts of the plaster matter. Such runoff is a waste of the plaster material, and may create environmental problems under certain circumstances.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a partially broken away pictorial view of the plaster panel manufacturing system in accordance with an embodiment of the present invention;

FIG. 2 is a fragmentary side view of the feeder and forming portions of the system of FIG. 1;

FIG. 3 is a fragmentary side view of an alternative embodiment of the overlap folding device;

FIGS. 3A-3C are fragmentary sectional views of the overlap folding station of FIG. 3;

FIG. 4 is a fragmentary side view of the second mesh layer press down roller and the bevel forming roller of the system of FIG. 1;

FIG. 5 is a fragmentary sectional view of the continuous plaster panel in the system of FIG. 1 taken substantially along line 5-5 in FIG. 4; and

FIG. 6 is a fragmentary sectional view of the continuous plaster panel in the system of FIG. 1 taken substantially along line 6-6 in FIG. 4.

### CERTAIN EMBODIMENTS OF THE INVENTION

Certain embodiments of the present invention will now be described more fully hereinafter with reference to the accompanying drawings, in which some, but not all, embodiments of the invention are shown. Indeed, these embodiments of the invention may be in many different forms and thus the invention should not be construed as limited to the embodiments set forth herein. Rather, these embodiments are provided as illustrative examples only so that this disclosure will satisfy applicable legal requirements. Like numbers refer to like elements throughout.

According to certain disclosed embodiments of the present invention, there is provided a system and method of making plaster panels to use in the construction of a wall of a building in a relatively faster, easier, more efficient, and more precise manner for either interior or exterior walls. The created plaster panels may include a slab of cementitious composition including a mixture of sizes of cut expanded polystyrene, a quantity of monofilament fiber, and a binding agent. At least one layer of a mesh may surround the slab, wherein the resulting panel is light in weight, flexible and strong. Such panels may be fixed in place to a building frame by suitable fasteners such as nails or screws, while causing little or no fracturing of the panel.

Typically, the cementitious composition may include about 1.5% by weight cut expanded polystyrene, about 0.5% by weight polypropylene monofilament fiber, about 35% by weight sand, about 35% by weight cement, about 7% by weight acrylic binding agent, about 0.1% by weight foam control agent, and a balance of water.

Typically, the mixture of cut expanded polystyrene may be comprised of cut expanded polystyrene pieces having an average size of about 2381 microns ( 3/32 inch). More typically, the mixture of the cut expanded polystyrene pieces may be comprised of about 50% cut expanded polystyrene pieces having a size of about 3175 microns (⅛ inch) and about 50% cut expanded polystyrene pieces having a size of about 1587.5 microns ( 3/16 inch). The cut expanded polystyrene may be cut from expanded polystyrene with a foam density of a suitable weight such, for example, as about one pound.

The mesh may be a reinforcing alkali resistive mesh such as a fiberglass mesh tape. The plaster panel may be comprised of two layers of mesh which substantially encase the plaster panel.

The polypropylene monofilament fiber typically may have a density of 1.0 lb/cubic yard. Typically the sand may have a 60 grit construction grade sand and the cement may be a type 2 Portland cement. The acrylic binding agent may be liquid acrylic or aqueous acrylic emulsion.

The created plaster panels may receive fasteners such as nails and screws directly with little or no fracturing such as cracking of the plaster panel for certain applications. Typically, the plaster panels may have opposite side edges which are beveled. Such a construction of the plaster panel of embodiments of the invention enable like panels to be installed in a smooth continuous manner in a variety of dispositions such as vertical or horizontal. The panel typically may have dimensions of about four feet in width by about eight feet in length by about three quarters of an inch in thickness. However, other dimensions may also be employed for other applications. Furthermore, the surface of the created plaster panel may exhibit a rough stipple finish, a smooth slick finish, or other.

According to another embodiment of the invention, a method of making a plaster panel may include placing a first continuous layer of mesh on a conveyor belt moving at a predetermined velocity, placing a cementitious composition on top of the layer of mesh, distributing the cementitious composition substantially uniformly on the conveyor belt between a pair of vertical fences into a continuous slab, folding extending portions of the mesh over outside edges of the continuous slab, pressing a second continuous layer of mesh onto the top of the continuous slab, partially curing the cementitious composition within the continuous slab with mesh into a substantially solid continuous plaster panel, and cutting the continuous plaster panel into individual plaster panels.

According to yet another embodiment of the invention, a system of making a plaster panel may include a conveyor belt moving at a predetermined velocity, a first mesh layer station for providing a first layer of mesh onto the conveyor belt, a cementitious composition feeder for providing a cementitious composition onto the first layer of mesh on the conveyor belt, a pair of vertical fences disposed on top of the first mesh layer on the conveyor belt and defining the width of the plaster panels, a spreader for substantially evenly distributing the cementitious composition on the conveyor belt between the vertical fences into a continuous slab, a first roller die to compress the continuous slab to the desired thickness, a folding device to fold extending edges of the first layer of mesh up to the outside edges of the continuous slab, a second mesh layer station for feeding a second layer of mesh onto the top of the continuous slab, a second roller to press the second layer of mesh into the top of the continuous slab to form a continuous plaster sheet, a curing station for at least partially curing the continuous plaster sheet, and a cutter for cutting the continuous plaster sheet into individual plaster panels.

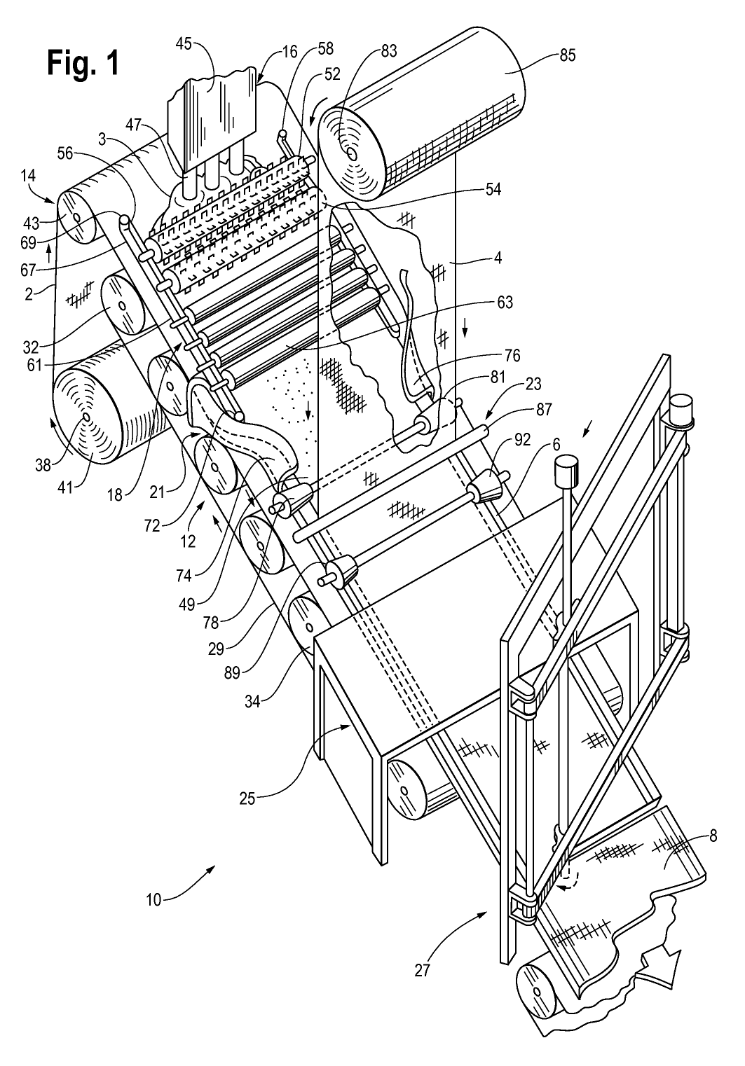

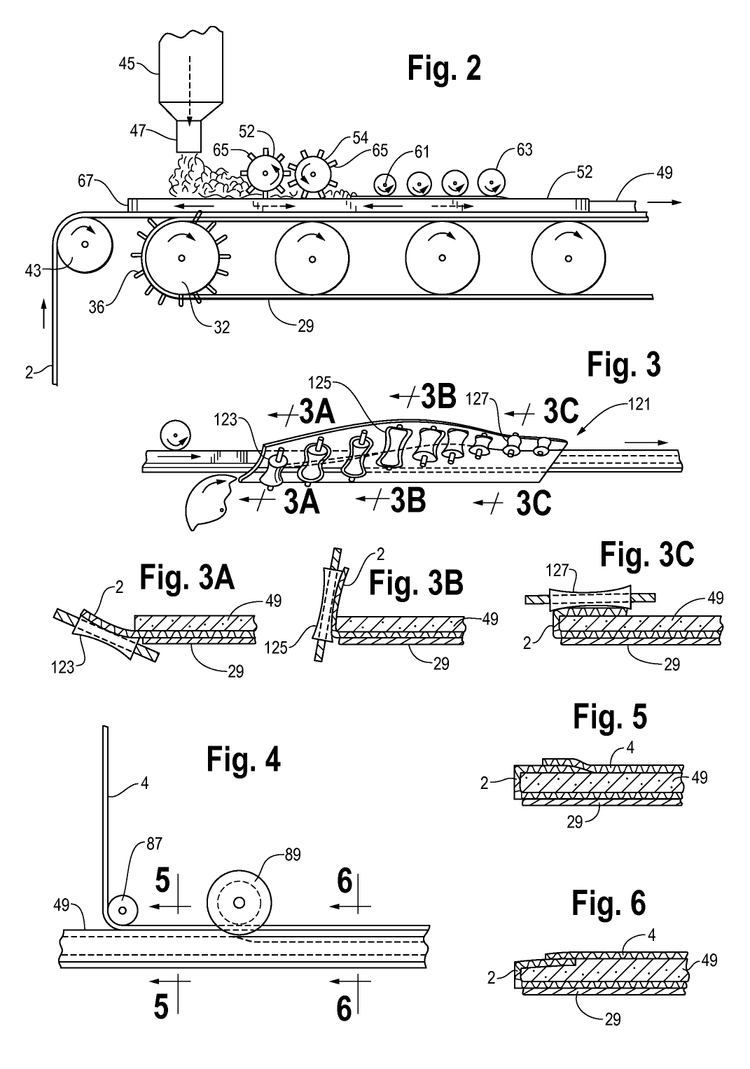

Referring now to FIGS. 1, 2, 4 through 6 of the drawings, there is shown a plaster panel manufacturing system 10, which is constructed in accordance with an embodiment of the present invention. The system 10 may use a first mesh layer 2, a cementitious composition 3, and a second mesh layer 4 to create a continuous plaster sheet 6 that is cut into individual plaster panels 8. The system 10 may include a conveyor portion 12, a first mesh layer station 14, a cementitious composition feeder station 16, a distribution and forming station 18, an overlap folding station 21, a second mesh layer station 23, a curing station 25, and a cutting station 27.

The conveyor portion 12 may include a conveyor belt 29 extending at least the entire length of the system 10 and operating at a constant speed using a plurality of rollers, such as rollers 32 and 34. At least one of the plurality of rollers may be rotated by a motor (not shown) at the constant speed of the conveyor belt. The roller 32 may include a plurality of extending pins 36 on each end of the roller 32 to engage the first mesh layer 2 and prevent slippage between the first mesh layer 2 and the conveyor belt 29.

The first mesh layer station 14 provides the first mesh layer 2 to the conveyor portion 12 and may include a spindle 38 holding a roll of mesh 41 and a roller 43 that introduces the first mesh layer 2 to the conveyor belt 29. The roller 43 may be free rolling and have a length of at least the width of the first mesh layer 2.

The cementitious composition feeder station 16 provides the cementitious composition 3 upon the first mesh layer 2 on the conveyor belt 29 and may include a mixture tank (not shown) connect to a feeder 45 that concludes with a plurality of nozzles 47 introducing the cementitious composition 3 upon the first mesh layer 2 prior to proceeding to the distribution and forming station 18.

The distribution and forming station 18 creates an appropriately sized slab 49 on the first mesh layer 2 using the cementitious composition 3 provided by the feeder station 16. The distribution and forming station 18 may include a pair of distribution rollers 52, 54 for distributing the cementitious composition 3 over the first mesh layer 2, a pair of moving fences 56, 58 that define the width of the slab 49 by limiting the distribution of the cementitious composition 3 upon the first mesh layer 2, and a plurality of forming rollers, such as rollers 61 and 63, that refine the shape of the slab 49 into its final form.

The distribution rollers 52, 54 may be rotated by a motor (not shown) and include a plurality of extending paddles 65 to assist with spreading the cementitious composition 3 in a generally even manner upon the first mesh layer 2.

Each of the moving fences 52, 54 may include a vertically oriented belt 67 around a plurality of rollers, such as rollers 69 and 72. At least one of the rollers may be rotated by a motor (not shown) to move the belt 67 at the same speed as the conveyor belt 29.

The plurality of forming rollers may step-wise increase in diameter from the first forming roller 61 to the last forming roller 63 to gradually refine the shape of the slab 49 into its final form. The forming rollers may assist with distributing and pressing the cementitious composition evenly upon the first mesh layer 2 between the two moving fences 52, 54 and define the desired thickness of the slab 49.

The overlap folding station 21 folds the portions of the first mesh layer 2 extending from the slab 49 over the outer sides of the slab 49 and onto adjacent portions of the top of the slab 49. The overlap folding station 21 may include a pair of folding devices 74, 76 and a pair of rollers 78, 81 to press the overlapping portions of the first mesh layer 2 into the top of the slab 49. Each of the folding device 74, 76 may be elongated and contoured to gradually fold the appropriate extending portion of the first mesh layer 2 first around the outer side of the slab 49 and then onto the adjacent portion of the top of the slab 49.

The second mesh layer station 23 provides the second mesh layer 4 to the cover the top of the slab 49 and may include a spindle 83 holding a roll of mesh 85 and a roller 87 that introduces and presses the second mesh layer 4 into the top of the slab 49 overlapping at least a portion of the each of the ends of the first mesh layer 2 overlapped onto the top of the slab 49 as shown in FIG. 5. The roller 87 may be free spinning and have a length of at least the width of the second mesh layer 4. A pair of bevel forming rollers 89, 92 may further compress the ends of the slab 49 with the overlapping first and second mesh layers 2, 4 completing the formation of the continuous plaster sheet 6 having beveled edges as shown in FIG. 6 prior to it proceeding to the curing station 25.

The curing station 25 may provide a controlled environment that sufficiently cures the continuous plaster sheet 6 so that it may be cut into plaster panels 8 at the cutting station 27. The temperature and humidity in the curing station 25 may be controlled to partially cure the continuous plaster sheet 6 to maximize its strength and durability.

The cutting station 27 may include a water jet cutter 94 that is mounted on and moved across a frame 96 that is set at a non-perpendicular angle relative to the conveyor belt 29 to permit a perpendicular cut of the continuous plaster sheet 6 moving on the conveyor belt 29 into the desired sized plaster panels 8.

Referring now to FIGS. 3 and 3A through 3B, an alternate embodiment of the overlap folding station is shown and generally referenced as 121. The overlap folding station 121 provides substantially the same function as overlap folding station 21 by using a plurality of folding rollers, such as rollers 123, 125, and 127, in place of the elongated folding device and a press down roller. The plurality of folding rollers may gradually fold the appropriate extending portion of the first mesh layer around the outer side of the slab and onto the adjacent portion of the top of the slab. As shown in FIGS. 3A through 3C, roller 123 may initiate the folding of the extending portion of the first mesh layer, roller 125 may press a portion of the first mesh layer into the outer side of the slab, and roller 127 may press the remaining extending portion of the first mesh layer into the adjacent top portion of the slab.

In operation, the method of making a plaster panel may be initiated by placing a first continuous layer of mesh on a conveyor belt moving at a predetermined velocity. A cementitious composition may then be placed on top of the first layer of mesh. Next the cementitious composition may be distributed in a substantially uniform manner on the first layer of mesh between a pair of vertical fences into a continuous slab. Extending portions of the first layer of mesh may then be folded over the outside edges and a portion of the top of the continuous slab. A second layer of mesh may be pressed onto the top of the continuous slab overlapping at least a portion of the first mesh layer folded over the top of the continuous slab creating a continuous plaster sheet. The outside edges of the continuous plaster sheet may then be beveled. Next the continuous plaster sheet may be partially cured into a substantially solid continuous plaster sheet. The substantially solid continuous plaster sheet may then be cut into individual plaster panels. Last the individual plaster panels may be stored in an at least partially controlled environment to complete the curing of the cementitious composition within the individual plaster panels.

The plaster panel created using the above method includes a centrally disposed cementitious slab, which is generally rectangular in configuration, and a pair of layers of mesh disposed on the outside surfaces of the slab to substantially surround it. The plaster panel is generally rectangular in configuration and is preferably 4 feet in width by 8 feet in length by three quarters of an inch in depth, but may also assume various different sizes and shapes. The panel has a pair of longitudinal complementary side edges in the form of chamfered or beveled configurations. In this manner, the complementary beveled side edges enable them to cooperate with similar complementary edges of like panels.

The plaster panel may be affixed by suitable fasteners such as screws or nails to a building frame to form a wall. Like plaster panels may be fitted together at their complementary side edges to form a continuous wall such as a planar wall, or other desired configurations. The beveled side edge of the plaster panel mate with the adjacent beveled side edge of an adjacent plaster panel to form a V-shaped seam integration cavity. Suitable tape, such as fiberglass mesh tape, may be used to tape over the V-shaped integration cavities. After taping the cavities, a cementitious coating may then be applied over the entire wall and thereby forming these V-shaped projections to fill the seam integration cavities. The cementitious coating 79 may be composed of about 1.5% by weight cut expanded polystyrene, about 0.5% by weight polypropylene monofilament fiber, about 35% by weight sand, about 35% by weight cement, about 7% by weight acrylic binding agent, about 0.1% by weight foam control agent, and a balance of water.

The embodiments of the system and method of making plaster panels create plaster panels that provide environmental safeguards when compared to conventional stucco walls. Traditionally, stucco walls have been applied in several layers, with a substantial amount of waste run off of the stucco material during settling, which may be washed into the sewer system. Use of the plaster panels created by the embodiments of the invention may not require several applications of stucco, and thus, they generally do not exhibit undesirable run off of the stucco material as any run off may be minimized or greatly reduced.

Additionally, cement presently is in short supply, and therefore it is highly desirable to conserve cement consumption. By eliminating several applications of stucco for certain conventional installations, the use of the plaster panel created by the embodiments of the invention may result in a decreased consumption of cement. Furthermore, the manufacturing of the plaster panels in a factory environment may allow for the recycling of any waste products of cementitious composition.

The plaster panel created by embodiments of the invention may be installed quickly and efficiently. Traditional methods of applying stucco to the exterior walls of a building have under certain circumstances required approximately 12-13 days of spraying, followed by up to about 30 days of drying time for certain installations. Often fracturing such as cracking would occur in certain applications during the drying time thereby necessitating additional stucco layers to be applied. The plaster panels created by the embodiments of the present invention essentially eliminate or at least greatly reduce excessive installation time for at least certain applications.

It should be understood that when words such as “about,” “approximately,” “substantially” or the like are used herein, a tolerance of plus or minus 20 percent may be employed.

Although the invention has been described with reference to the above examples, it will be understood that many modifications and variations are contemplated within the true spirit and scope of the embodiments of the invention as disclosed herein. Many modifications and other embodiments of the invention set forth herein will come to mind to one skilled in the art to which the invention pertains having the benefit of the teachings presented in the foregoing descriptions and the associated drawings. Therefore, it is to be understood that the invention shall not be limited to the specific embodiments disclosed and that modifications and other embodiments are intended and contemplated to be included within the scope of the appended claims. Although specific terms are employed herein, they are used in a generic and descriptive sense only and not for purposes of limitation.

What is claimed is:

1. A system for making plaster panels, comprising:
a conveyor belt moving at a predetermined velocity;
a first mesh layer station for providing a first layer of mesh onto the conveyor belt;
a cementitious composition feeder for providing a cementitious composition onto the first layer of mesh on the conveyor belt;
a pair of vertical fences disposed on top of the first mesh layer on the conveyor belt and defining the width of the plaster panels;
a spreader for substantially evenly distributing the cementitious composition on the conveyor belt between the vertical fences into a continuous slab;
a first roller to compress the continuous slab to the desired thickness;
a folding device to fold extending edges of the first layer of mesh up to the outside edges of the continuous slab;
a second mesh layer station for feeding a second layer of mesh onto the top of the continuous slab;
a second roller to press the second layer of mesh into the top of the continuous slab to form a continuous plaster sheet;
a curing station for at least partially curing the continuous plaster sheet; and
a cutter for cutting the continuous plaster sheet into individual plaster panels.

2. The system of claim 1, wherein the spreader includes a pair of rotating rollers having a plurality of paddles.

3. The system of claim 1, wherein the first roller includes a plurality of rollers of varying diameters.

4. The system of claim 1, wherein the folding device includes an elongated contoured member.

5. The system of claim 1, wherein the folding device includes a plurality of folding rollers.

6. The system of claim 1, wherein the vertical fences move at the predetermined velocity.

7. The system of claim 1 further including a pair of rollers to bevel the outer edges of the continuous plaster sheet.

8. The system of claim 1, wherein the cutter includes a water jet cutter.

9. The system of claim 1, wherein the cutter includes a frame disposed at a non-perpendicular angle to the conveyor belt.

10. The system of claim 9, wherein a water jet cutter is moved across the frame to make a perpendicular cut in the continuous plaster sheet moving on the conveyor belt.

11. A method of making a plaster panel, comprising:
placing a first continuous layer of mesh on a conveyor belt moving at a predetermined velocity;
placing a cementitious composition on top of the layer of mesh;
distributing the cementitious composition substantially uniformly on the conveyor belt between a pair of vertical fences into a continuous slab,
folding extending portions of the mesh over outside edges of the continuous slab;
pressing a second continuous layer of mesh onto the top of the continuous slab;
partially curing the cementitious composition within the continuous slab with mesh into a substantially solid continuous plaster sheet; and
cutting the continuous plaster sheet into individual plaster panels.

12. The method of claim 11, further comprising folding the extending portions of the mesh over the top of the continuous slab.

13. The method of claim 12, wherein a portion of the second layer of mesh overlaps the first layer of mesh on the top of the continuous slab.

14. The method of claim 11, further comprising beveling the outside edges of the continuous slab.

15. The method of claim 11, wherein the continuous slab is about four feet wide.

16. The method of claim 11, wherein the continuous slab is about ¾ inch thick.

17. The method of claim 11, wherein the individual plaster panels are about four feet wide by about eight feet long.

18. The method of claim 11, further comprising storing the individual panels in an at least partially controlled environment to complete the curing of the cementitious composition with the individual plaster panels.

19. The method of claim 11, where the cementitious composition includes a mixture of sizes of cut expanded polystyrene, a quantity of monofilament fiber and a binding agent.

20. The method of claim 11, wherein the vertical fences are moving at the predetermined velocity.

21. The method of claim 11, wherein the cementitious composition includes:
about 1.5% by weight mixture of cut expanded polystyrene;
about 0.5% by weight polypropylene monofilament fiber;
about 35% by weight sand;
about 35% by weight cement;
about 7% by weight acrylic binding agent;
about 0.1% by weight foam control agent; and
a balance of water.

22. The method of claim 11, wherein the mesh is a reinforcing alkali resistive mesh.

23. The method of claim 21, wherein the cut expanded polystyrene includes cut expanded polystyrene pieces having an average size of about 2381 microns.

24. The method of claim 21, wherein the cut expanded polystyrene includes about 50% cut expanded polystyrene pieces having a size of about 3175 microns and about 50% cut expanded polystyrene pieces having a size of about 1587.5 microns.

25. The method of claim 21, wherein the cut expanded polystyrene is cut from expanded polystyrene with a foam density of about one pound.

26. The method of claim 21, wherein the polypropylene monofilament fiber has a density of 1.0 lb/cubic yard.

27. The method of claim 21, wherein the sand is a 60 grit construction grade sand.

28. The method of claim 21, wherein the cement is type 2 Portland cement.

29. The method of claim 21, wherein the acrylic binding agent is liquid acrylic or aqueous acrylic emulsion.

30. The method of claim 11, wherein the individual plaster panels have dimensions of about four feet in width by about eight feet in length by about three quarter of an inch in thickness.

31. The method of claim 11, wherein each of the individual plaster panels has a surface exhibiting a rough stipple finish.

32. The method of claim 1, wherein each of the individual plaster panels has a surface exhibiting a smooth slick finish.
